(19) United States
(12) Patent Application Publication
(10) Pub. No.: US 2005/0081535 A1
(43) Pub. Date: Apr. 21, 2005

(54) Spiral tube LNG vaporizer

(76) Inventor: Gerald E. Engdahl, Wheaton, IL (US)

Correspondence Address: GERALD E. ENGDAHL, 1425 OXFORD LANE, WHEATON, IL, 60187, US

(21) Appl. No.: 10/961,621

(22) Filed: Oct. 8, 2004

Related U.S. Application Data
(60) Provisional application No. 60/516,845, filed on Nov. 3, 2003.
(60) Provisional application No. 60/511,827, filed on Oct. 16, 2003.

(51) Int. Cl. F17C 9/02

(52) U.S. Cl. 62/50.2

(57) ABSTRACT

This invention relates to a device for vaporizing LNG. A second aspect of the invention includes a method of vaporizing LNG. A third aspect of the invention includes utilizing a submerged combustion heat source for vaporizing LNG. The LNG vaporizer includes a plurality of LNG spiral tube circuits communicating to an inlet manifold and to an outlet manifold. The LNG spiral tube circuits are positioned within a heating medium flow arrangement annular space.

### RELATED APPLICATIONS

This application claims domestic priority from provisional application Ser. No. 60/516,845, SPIRAL TUBE LNG VAPORIZER filed Nov. 3, 2003 and provisional application Ser. No 60/511,827, SUBMERGED COMBUSTION WATER HEATER filed Oct. 16, 2003, the entire disclosures of which are incorporated herein by reference. Engdahl U.S. Patent application SUBMERGED COMBUSTION LNG VAPORIZER filed on Oct. 8, 2004 and Engdahl U.S. Patent application SUBMERGED COMBUSTION WATER HEATER filed on Oct. 8, 2004 are incorporated herein by reference.

### FIELD OF THE INVENTION

The present invention relates generally to vaporizing liquefied natural gas (LNG). More specifically, the present invention relates to an effective heat transfer apparatus and method for using a heating medium such as sea water to vaporize LNG.

### BACKGROUND OF THE INVENTION

Liquefied natural gas is stored at many locations throughout the world. The LNG is used when a local source of natural gas is not available or as a supplement to local and regional sources. Liquefied natural gas is typically stored at low pressure in the liquid state at cold temperatures. The LNG is usually pumped to a pressure that is slightly above the pressure of the natural gas distribution pipeline. The high pressure liquid is vaporized and sent to the pipeline. The vaporizers can use a fired heat source or use an energy efficient source of heat such as sea water or river water.

Open rack, shell and tube and intermediate fluid vaporizer fluid vaporizers are generally used to vaporize LNG using sea water as the heat source. These vaporizers are all subject to thermal stresses which can damage the vaporizer and lead to failure of the apparatus. The present invention discloses a vaporizer less susceptible to thermal stresses, provides a vaporizer which can be brought on line quickly, is economic and reliable, and can utilize water, sea water and other fluids as the heating medium and heat source.

Another type of LNG vaporizer utilizes fired heat sources. The submerged combustion LNG vaporizer (SCV) is a fired heat source type vaporizer used in LNG service. The SCV includes a heat transfer coil installed in a liquid bath. The vaporizer is equipped with submerged combustion burners firing into the liquid bath. The burner system includes a large high horsepower blower for providing combustion air. The submerged combustion burner provides heat, circulation, and turbulence for heat transfer.

U.S. Pat. No. 4,605,059 discloses plastic tube circuits wound in a helical manner. Each helical circuit is wrapped at a different diameter. The result is parallel connected helical circuits with each helical circuit being of a different length. The length difference can result in large differences in flows and heat transfer between the parallel helical circuits with negative impact. The helical circuits are wrapped around a core to form an exchanger element. The exchanger element is inserted into a casing with an inlet and outlet.

U.S. Pat. No. 6,325,139 also discloses tube circuits wound in a helical manner (the patent states spiral, but the tubes are actually helical circuits, wound like winding a garden hose on a hose reel). As in U.S. Pat. No. 4,605,059 multiple helical circuits are provided. Each circuit has a different diameter. The circuits of U.S. Pat. No. 6,325,139 are adjusted to provide circuits of equal length by decreasing the number of coils in the circuits with the larger helix diameter. The coil assembly is positioned in a drum.

These are several U.S. patents disclosing plastic tubes in spiral coil, helical coil and conical coil heat arrangements. The coils are placed in a tank. A coolant circulates within the tubes to freeze water or a water solution on the outside of the tubes. These heat exchangers are used as thermal energy storage devices generally in air conditioning applications.

The submerged combustion heat exchanger disclosed in U.S. Pat. No. 3,368,548 utilizes submerged combustion burners firing into a heat exchange liquid bath containing a serpentine coil heat exchanger. The products of combustion from the high back pressure burners are used to provide heat exchanger liquid circulation within the bath for heat transfer with the serpentine coil.

The above patents do not teach or suggest the heating medium flow arrangement of this disclosure nor do they present the spiral tube circuits, the spiral tube support system, the assembly method and many other features of the apparatus used to provide an effective heat transfer arrangement to vaporize LNG as taught in this specification.

### OBJECTIVES

Several objectives of this patent follow:
To provide an effective heat transfer arrangement to reliably vaporize LNG.
To directly vaporize LNG with energy efficient heat sources such as sea water, river water, waste heat or cooling tower water and other heat sources such as water from a submerged combustion water heater.
To directly vaporize LNG with heat sources containing particulate matter.
To provide a heating medium arrangement to obtain high heat transfer rates using cross flow heat transfer.
To provide a vaporizer which can be started quickly and operate with stable outlet LNG flows over a range of LNG flow rates.
To provide a vaporizer where the spacing of the colder heat transfer tubes containing LNG can be configured to accommodate heating medium icing.
To accommodate the heating and vaporizing of many cold fluids utilizing various heating mediums and heat sources.
To operate with a stable outlet gas composition essentially the same as the inlet LNG composition.
To provide an apparatus for vaporizing LNG at high operating pressures.
To provide an arrangement which helps keep particles in the heating medium from settling within the heat transfer area.
To provide a vaporizer utilizing a submerged combustion heat source.
To provide a vaporizer with reduced potential for LNG liquid carryover for increased vaporizer reliability.
To provide a vaporizer with reduced thermal stresses from heat transfer tube movement for increased vaporizer reliability.
To provide a vaporizer with high heat transfer rates without using auxiliary air to promote turbulence.
To provide a vaporizer utilizing a submerged combustion heat source where the products of combustion do not impinge or contact the LNG heat transfer area.
To provide a vaporizer for installation below grade, above grade or partly below grade.
To provide a rugged vaporizer for installation on ships, offshore locations, or onshore locations.
To provide a vaporizer having a compact footprint.
To provide a high capacity LNG vaporizer.
To provide a vaporizer including provisions for a hydrocarbon liquid separator.

### SUMMARY OF THE INVENTION

In accordance with one aspect of the invention, a method of vaporizing LNG includes the steps of providing at least one heating medium entrance, providing a heating medium annular space, providing spiral tube heat transfer circuits positioned in the annular space, flowing LNG through the spiral tube heat transfer circuits, flowing heating medium through at least one heating medium entrance and through the annular space, and providing heating medium heat exchange with the spiral tube heat transfer circuits.

In accordance with another aspect of the invention, a LNG vaporizer device comprising rows of spiral tube circuits for containing LNG, at least one inlet manifold and at least one outlet manifold, wherein spiral tube circuits communicate with at least one inlet manifold, at least two annular space shell plates disposed to form a heating medium annular space, wherein rows of spiral tube circuits being positioned generally within the annular space, a heating medium inlet plenum communicating with the annular space, and a heating medium outlet plenum communicating with the annular space.

In accordance with yet another aspect of the invention, a LNG vaporizer device comprising rows of spiral tube heat transfer circuits for containing LNG, at least two annular space shell plates disposed to form a heating medium annular space, wherein the rows of spiral tube heat transfer circuits being positioned generally within the annular space, a vaporizer heating medium inlet plenum communicating with the annular space, a vaporizer heating medium outlet plenum communicating with the annular space, a submerged combustion heat source with a submerged combustion heat source inlet plenum and a submerged combustion heat source outlet plenum, wherein the vaporizer heating medium outlet plenum communicates with the submerged combustion heat source inlet plenum and the vaporizer heating medium inlet plenum communicates with the submerged combustion heat source outlet plenum, and at least one pump circulating heating medium from the vaporizer heating medium outlet plenum, through the submerged combustion heat source and through the annular space for heat exchange with the spiral tube heat transfer circuits.

A method of manufacturing a LNG vaporizer annular space assembly comprising the steps of forming heat exchange tubes into spiral tube circuits, fabricating annular space shell plates, providing support rod holes, preparing support rods, preparing LNG manifolds, fabricating a spiral tube circuit row to include positioning several support rods through holes, placing a spiral tube circuit row on support rods, connecting the spiral tube circuit to manifolds, and fabricating multiple spiral tube circuit rows each in succession to form an annular space assembly.

### BRIEF DESCRIPTION OF THE DRAWINGS

FIG. 1 is an elevation view cross section of a cylindrical vaporizer pertaining to the present invention.

FIG. 2 is a plan view cross section showing an example of the cylindrical vaporizer pertaining to the present invention. The cover is removed.

FIG. 3 is an elevation view cross section of the cylindrical vaporizer pertaining to the present invention utilizing a submerged combustion heat source.

FIG. 4 is a detail of two spiral tube circuits resting on support rods within the annular space.

FIG. 5 is a partial plan view detail including a LNG inlet manifold.

FIG. 6 is partial elevation view detail of a pair of shell gap baffle bars.

FIG. 7 is a detail of an orifice rod.

FIG. 8 is a detail of a heating medium bar baffle.

FIG. 9 is a detail of a stand-off bar.

FIG. 10 is an elevation view cross section of a cylindrical vaporizer pertaining to the present invention.

### DETAILED DESCRIPTION OF THE INVENTION

The present invention discloses effective heat transfer arrangements for the reliable vaporization of LNG. The devices are configured for high heat transfer rates and low thermal stresses.

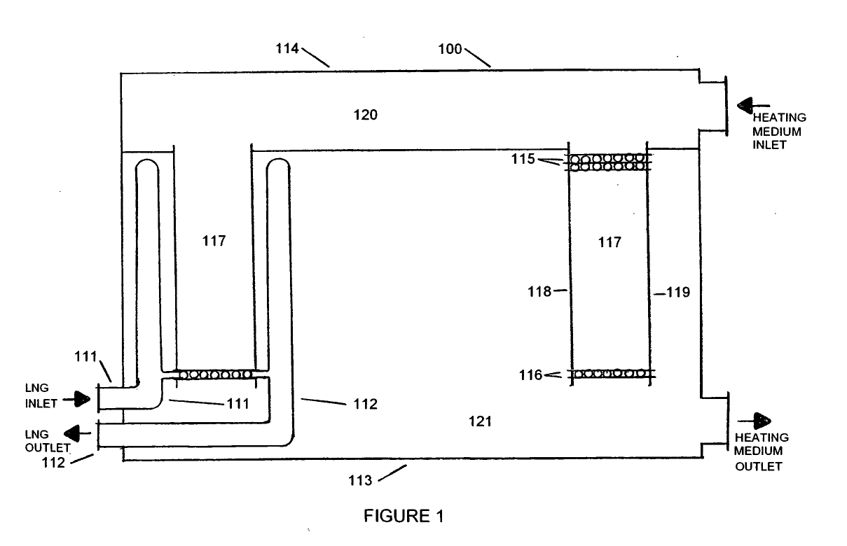

Referring to FIG. 1, a vaporizing device 100 embodying features of this invention is illustrated. The vaporizing device 100 has a LNG inlet manifold 111, a LNG outlet manifold 112, and a heating medium outer containment vessel 113 with a removable cover 114. The LNG inlet manifold receives LNG from pumps, generally at high pressure. The inlet end of a heat transfer spiral tube circuit 115 connects and communicates with inlet manifold 111. The outlet end of the spiral tube circuit connects and communicates with LNG outlet manifold 112. Multiple rows of vertically stacked spiral tube circuits 115 are connected to the LNG manifolds. The plurality of spiral tube circuits 115 containing flowing LNG provide heat transfer area for vaporizing the LNG. The heat transfer spiral tube circuits can be provided with inlet orifices for distribution and core busters for increased heat transfer. Considerable vaporizer surface area can be provided by the multiple rows of spiral tube circuits. Very high LNG flows can be vaporized in a compact single unit.

Each spiral tube circuit 115 row rests on several support rods 116. The support rods 116 span the annular 117. The annular space 117 is the annular space between inner annular space shell plate 118 and outer annular space shell plate 119. The annular space 117 is positioned within the heating medium containment vessel 113. A plurality of spiral tube circuits 115 is located within the annular space 117. The heating medium inlet plenum 120 communicates with the upper part of annular space 117. The heating medium outlet plenum 121 communicates with the lower part of annular space 117. The heating medium flowing through the annular space is in cross flow heat exchange contact with LNG flowing through the plurality of spiral tube circuits. FIG. 1 shows an arrangement where the heating medium flows in a single pass downward through the annular space 117. The heating medium inlet plenum 120 communicates with the upper portion of the annular space 117. Some applications will require the heating medium flow through the annular space to be upward through the annular space. The vaporizer can be designed for a reversed heating medium flow path through the annular space. The inlet plenum for this reverse flow arrangement would be located at the bottom of the vaporizer. Vent conduits (not shown on FIG. 1) are included to vent vapors from various regions within the heating medium portion of containment vessel 113.

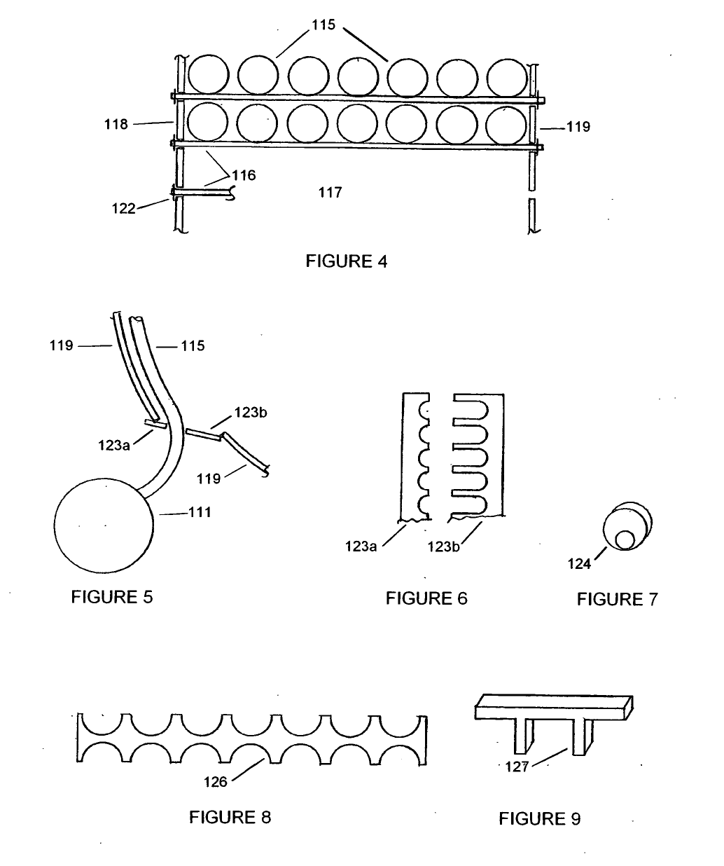

Referring to FIG. 4, two rows of spiral tube circuits 115 are shown supported by support rods 116 within annular space 117. Holes are provided in annular space shell plate 118 and annular space shell plate 119 to accept the support rods 116. Support bars and other types of devices can be used to support the spiral tube circuits. The support rods are held in place with flat push nuts 122. Other types of fasteners can be used to secure the support rods. The spiral tube circuits 115 are shown in the aligned position in FIG. 4 where each tube within the spiral tube circuit is placed generally vertically above each tube in the row below. The spiral tube circuits can also be placed in the staggered position where each tube within the spiral tube circuit is placed generally above the gap in the row below. The vertical centerline spacing of support rods 116 is slightly larger than the sum of the outside diameter of a heat transfer tube plus the diameter of a support rod, providing vertical clearance such that movement of the tubes is not restricted by the above support rods. The rows of spiral tube circuits are not supported by tubes in the row below. Each row is supported by its system of support rods. The tube is not restricted from moving as it is cooled down or warmed up. Independent movement is provided for each spiral tube circuit row. The tube movement is generally in a radial direction. In many applications that portion of the spiral tube circuit nearest the cold inlet manifold will ice. The tube pitch of the tubes in a spiral tube circuit is adjusted in the design as required to accommodate the tube ice layer on the colder part of the spiral circuit and to allocate heating medium flow. Lack of heating medium flow around iced tubes can cause ice blockages. The design ability to increase the gap between iced tubes increases the reliability of the spiral tube vaporizer. A stand-off bar 127 is positioned over individual tubes within a spiral circuit where needed to maintain a minimum gap width between the tubes. One type of stand-off bar 127 is illustrated in FIG. 9. The stand-off bar 127 can also be provided with holes for heating medium flow. The stand-off bar 127 is positioned over tubes in a spiral tube circuit row slightly offset in a radial line. The stand-off bars 127 are positioned over each spiral tube circuit row as it is fabricated into the annular space. The tube pitch of tubes within a spiral tube circuit row may vary, requiring several models of stand-off bar 127. Each stand-off bar model would provide the required minimum gap width. During operation, heating medium circulates around all tubes in the spiral tube circuit to provide proper heat transfer performance.

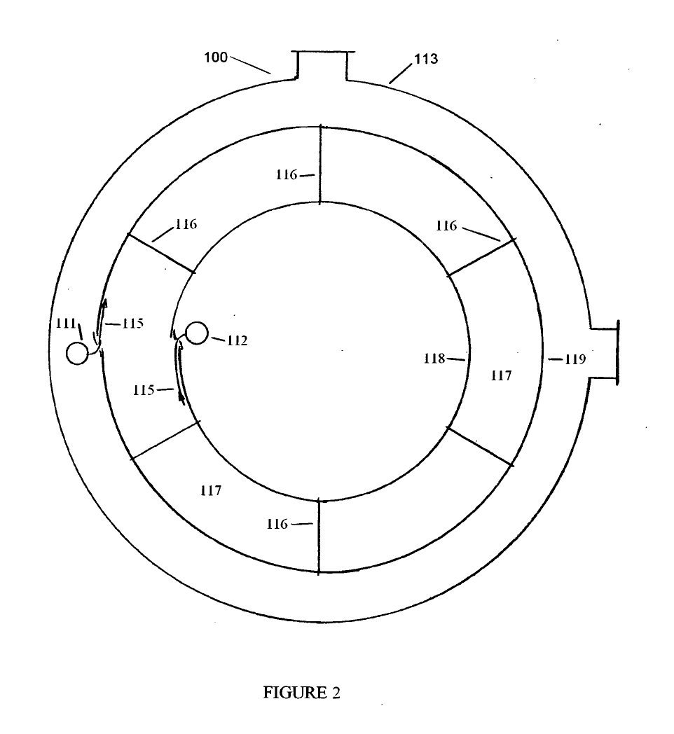

Refer now to FIG. 2, which is a plan view cross section of vaporizer 100 with the cover removed. As shown in FIG. 2, the width of annular space 117 formed between annular space shell plate 118 and annular space shell plate 119 is essentially uniform and is configured with a slight spiral. Support rods 116 are positioned within the annular space 117 for support of each row of spiral tube circuits. The inlet portion of one row of a spiral tube circuit 115 is shown connected to inlet manifold 111 and the outlet portion is shown connected to outlet manifold 112.

Refer now to FIG. 5, which is a plan view detail of the inlet end of spiral tube circuit 115 connecting to inlet manifold 111. The inlet end of each row of spiral tube circuits 115 passes through a gap in outer annular space shell plate 119. After all of the rows of spiral tube circuits 115 have been connected to inlet manifold 111, the gap in outer annular space shell plate 119 is closed with a pair of shell gap baffle bars 123a and 123b. The outlet end of spiral tube circuits 115 is connected to outlet manifold 112 in a manner similar to the detail shown in FIG. 5. The outlet end of spiral tube circuits 115 passes through a gap in inner annular space shell plate 118. This gap is also closed with a set of shell gap baffle bars 123a and 123b after the outlet end of all rows of spiral tube circuits have been connected to outlet manifold 112. A portion of the shell gap baffle bars 123a and 123b is detailed in FIG. 6. The shell gap baffle bar 123a as shown in FIG. 6 is inserted to fill the shell gap on one side of the spiral tube circuits and shell gap baffle bar 123b is inserted on the opposite side of the spiral tube circuits. The in place pairs of shell gap baffle bars are generally welded to the shell plates and to each other. The shell gap baffle bars are used to reduce the flow of heating medium bypassing the spiral tube circuits.

Refer now to FIG. 7 which details an orifice rod 124. The orifice rod is inserted into the inlet end of each row of spiral tube circuits 115 as an aid in distributing LNG to the rows of spiral tube circuits 115.

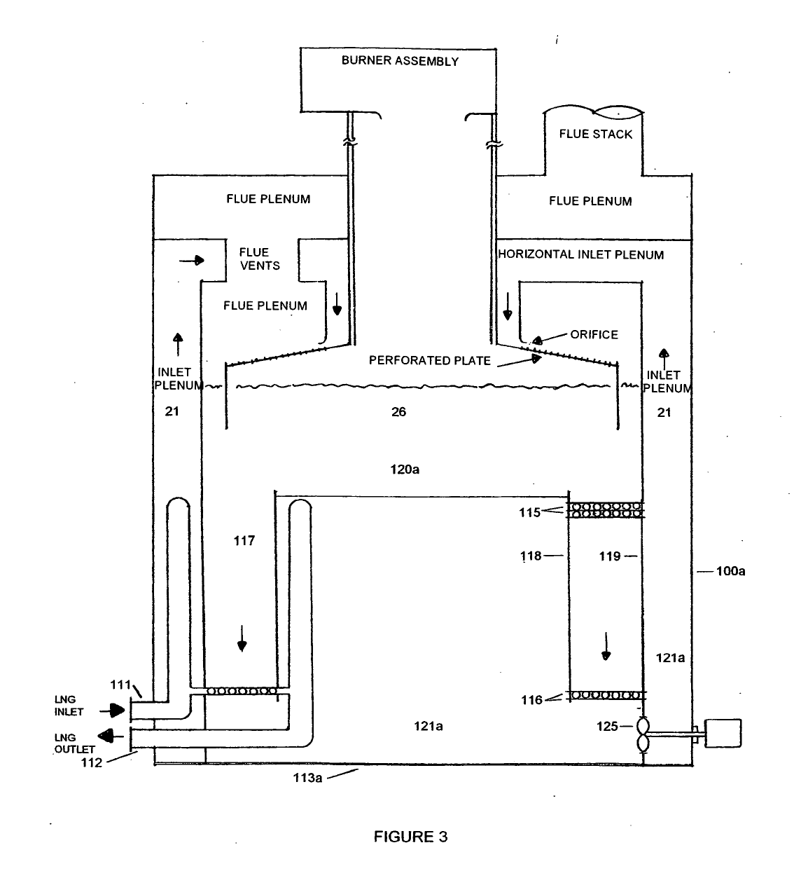

Refer now to FIG. 3, which is an elevation view cross section of the cylindrical vaporizer utilizing a submerged combustion heat source. The upper portion of FIG. 3 illustrates an embodiment teaching of Engdahl U.S. Provisional Patent No. 60/511827 for a SUBMERGED COMBUSTION WATER HEATER. In FIG. 3 the submerged combustion heat source water plenums have been arranged to connect and communicate with the LNG vaporizer device plenums. In FIG. 3 the water to be heated enters the submerged combustion heat source via inlet plenum 21. The water flows upward within the heat source inlet plenum 21 to the horizontal inlet plenum and into an annular down comer surrounding the combustion chamber. The water exits the down comer through an orifice and flows across a radial perforated plate where it is heated by heat and mass transfer contact with products of combustion passing through apertures in the perforated plate. The water exits the down comer orifice at a high velocity and flows generally across the top of the perforated plate as a high velocity stream. The heated water is collected in the heated water plenum 26 and directed downward through the vaporizer annular space containing the heat transfer circuits. The cooler water exiting the annular space is circulated via pump 125 to the submerged combustion heat source for heating.

The burner assembly fires into the combustion chamber and produces products of combustion gases. The products of combustion flow from the combustion chamber through apertures in the radial perforated plate. The products of combustion heat the water flowing over the perforated plate. The products of combustion exiting the perforated plate are collected in the flue plenums and flow through the flue stack to the atmosphere. An annular plate (not shown in FIG. 3) positioned above the perforated plate and attached to the plate forming the down comer can provide a flow passage space for heat and mass transfer contact between the water and products of combustion. The annular plate is located generally parallel to the perforated plate.

The lower portion of FIG. 3 illustrates a LNG vaporizing device 100a which includes inlet manifold 111, outlet manifold 112, an outer heating medium containment 113a, rows of spiral tube circuits 115, support rods 116, annular space 117, inner annular space shell plate 118, outer annular space shell plate 119, heating medium inlet plenum 120a and heating medium outlet plenum 121a. Heating medium outlet plenum 121a communicates with submerged combustion heat source inlet plenum 21. Heating medium inlet plenum 120a communicates with submerged combustion heat source outlet water plenum 26. The impeller of pump 125 is positioned in outlet plenum 121a. The pump 125 circulates the cooler heating medium to the heat source inlet plenum 21. The pump 125 can be an axial flow pump, propeller pump, centrifugal pump, ejector pump, or similar device for circulating large liquid flows at low head pressures. The water pump can be provided with a variable speed driver. The pump 125 can be positioned as shown in FIG. 3 or positioned external to LNG vaporizer heat transfer device 100a. The submerged combustion heat source as shown in FIG. 3 is positioned above the LNG vaporizer heat transfer device. Alternately the submerged combustion heat source can be located adjacent to the LNG vaporizer heat transfer device. Piping would be included as parts of the heating medium plenums communicating the LNG vaporizer heat transfer device to the adjacent submerged combustion heat source.

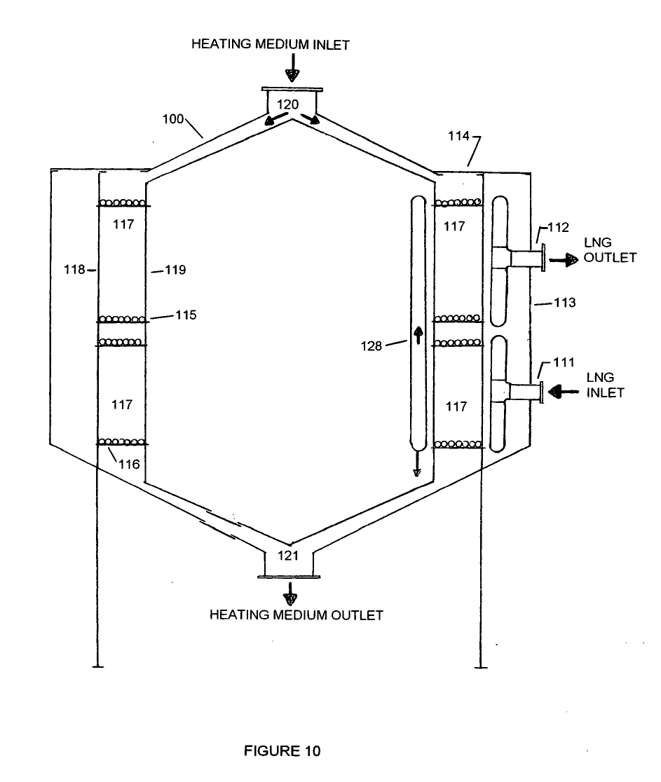

The plenum arrangement of the spiral tube vaporizer shown in FIG. 10 is configured to maintain a high heating medium velocity and maintain turbulence as the heating medium flows through the exchanger. The emphasis is having high heating medium velocities and maintaining the solids present in the heating medium in suspension. The heating medium flow path is arranged to eliminate stagnant heating medium flow regions. The FIG. 10 arrangement provides an effective means for vaporizing LNG using either dirty heating mediums or clean heating mediums as the source of heat.

Referring to FIG. 10, the vaporizing device 100 has a LNG inlet manifold 111, a LNG outlet manifold 112, and a heating medium outer containment vessel 113 with a removable cover 114. The inlet end of a lower heat transfer spiral tube circuit 115 connects and communicates with inlet manifold 111. The outlet end of the spiral tube circuit connects and communicates with LNG interstage manifold 128. The inlet end of an upper heat transfer spiral tube circuit connects and communicates with interstage manifold 128. Interstage manifold 128 is shown with a drain conduit in FIG. 10. The outlet end of an upper heat transfer spiral tube circuit connects and communicates with outlet manifold 112. Multiple rows of vertically stacked spiral tube circuits 115 are connected to the LNG manifolds. Each spiral tube circuit 115 row rests on several support rods 116. The support rods span the annular space 117. The annular space 117 is the annular space between inner annular space shell plate 118 and outer annular space shell plate 119. The annular space 117 is positioned within the heating medium containment vessel 113. A plurality of spiral tube circuits 115 is located within the annular space 117. The heating medium inlet plenum 120 includes a heating medium entrance. The heating medium inlet plenum 120 communicates with the upper part of annular space 117. The heating medium outlet plenum 121 communicates with the lower part of annular space 117. The heating medium entrance and heating medium inlet plenum are positioned concentric and symmetrical with the annular space. The heating medium inlet and outlet plenums and annular space are configured to eliminate stagnant heating medium flow regions.

The interstage manifold 128 shown in FIG. 10 can be designed additionally as a separator to collect and remove mostly heavy hydrocarbon liquids. Control can be included on manifold 128 to obtain the required separation. The separator can be included to provide a reduction in the send out LNG heating value. The spiral tube circuits of FIG. 10 can also be installed without the interstage manifold 128. The heating medium plenum arrangement would remain the same as shown in FIG. 10. The spiral tube circuits would connect to an inlet manifold and connect to an outlet manifold.

The LNG vaporizing devices depicted in FIG. 1, FIG. 2, FIG. 3 and FIG. 10 include a single pass heating medium flow through the annular space. The heating medium contacts the surface area containing LNG in a single pass. The LNG vaporizing device can be configured to provide a two pass heating medium flow arrangement. Annular space baffles are used to provide the two pass heating medium flow arrangement. Heating medium bar baffles 126 as detailed in FIG. 8 are inserted in the annular space 117 to provide a two pass heating medium flow arrangement. The heating medium bar baffles 126 are positioned in the annular space stacked above each other in a vertical plane to support the spiral tube circuits and provide a heating medium flow baffle. Two vertical stacks of heating medium bar baffles 126 are located in the annular space about 180 degrees apart. The heating medium inlet plenum and the heating medium outlet plenum are configured to provide a downward heating medium flow pass and an upward heating medium pass within the annular space.

The spiral tube circuits utilized in this disclosure are tubes wound in a spiral in a flat horizontal plane. Spiral winding vendors refer to this shape as a flat spiral.

Another variation of the LNG vaporizing device is obtained by arranging one spiral tube circuit to occupy two rows within the annular space. One half of the length of a spiral tube circuit is within one row in the annular space. The other half of the spiral tube circuit is within another row. A 180 degree return bend connector located outside the annular space connects the two halves of the spiral tube circuit and routes the two halves of one circuit to occupy two rows within the annular space. The LNG inlet manifold and the LNG outlet manifold are located on the same side of the annular space. The 180 degree return bend connector is located on the outside of the annular space generally opposite the location of the inlet and outlet manifolds.

Heat for vaporizing LNG is provided by the heating medium. The heating medium flows through a circuit including the heating medium inlet plenum, the annular space and the heating medium outlet plenum. The heating medium flowing through the annular space is in cross flow heat exchange contact with LNG flowing through the plurality of spiral tube circuits. Baffles which could induce heating medium flow dead spots are not required.

The steps of manufacturing the LNG vaporizer include:
Forming heat exchange tubes into spiral tube circuits.
Fabricating annular space shell plates with support rod holes.
Preparing support rods, and LNG manifolds.
Fabricating a spiral tube circuit row to include positioning several support rods through holes in at least one annular space shell plate, securing support rods, placing a spiral tube circuit row on support rods, connecting one end of the spiral tube circuit to a manifold and connecting the other end of the spiral tube circuit to a manifold.
Fabricating multiple spiral tube circuit rows each in succession to form an annular space assembly.
Providing and connecting shell gap baffle bars.
Fabricating heating medium plenums.
Position and fabricate the annular space assembly and heating medium plenums into an outer containment vessel.

Variations of the manufacturing sequence can include installing one of the annular space shell plates after the spiral tube circuits have been fabricated into the manifolds. Another variation includes utilizing several segments to form an annular space shell plate. The segments can be installed during various phases of the manufacturing sequence.

The LNG vaporizer can include several arrangements and variations. Modifications to the vaporizer manufacturing process may be required to accommodate the various arrangements and variations. Variations and arrangements of the vaporizer can include one of more of the following:
Several LNG inlet and outlet manifolds.
Several LNG interstage manifolds.
Two heating medium annular space passes.
Several types of spiral tube circuit annular space supports including support rods, support tubes, support bars and heating medium bar baffles.
The vaporizer can be configured with shapes other than cylindrical.
The containment position can be horizontal, at a slant or at other positions.
The heating medium can include particulate matter.
Annular space shell plates can include several segments connected during fabrication.
Several pumps can be provided to circulate the heating medium.
The vaporizer can be configured for use with particulate matter in the heating medium.

The heating medium contacts the heat transfer circuits in a cross flow arrangement. The cross flow heating medium flow configuration results in more uniform heat transfer rates. If ice is present, the ice formation on tubes is more uniform. If foreign material is present in the heating medium, turbulence of the cross flow vaporizer can reduce the quantity of settled material within the annular space. The vaporizer will have less fouling. The cross flow arrangement has increased heat transfer rates compared to parallel flow heating medium arrangements.

The vaporizer has features which facilitate cleaning of the heating medium side. A dirty heating medium side will reduce the heat transfer rates. Several options are available for cleaning and maintaining the heating medium side including the following:
Covers can be provided for increased access.
Provisions can be included to remove foreign material from the annular space and plenum areas.
Vaporizer systems would generally benefit from maintaining chlorine residual in the heating medium (the chlorine helps to maintain a cleaner system).

The present invention is designed for using sea water, river water, cooling tower water, other ambient waters and waste heat as energy efficient heat sources. The heat source can be from a submerged combustion water heater, other fired heaters and a gas turbine installation. The heat source fluid can generally be utilized in direct contact with the vaporizer heat transfer surface. The heating mediums can be seawater with silt, typical seawater with particulates, dirty river water, hot or warm water, a water glycol solution, cooling tower water, hydrocarbons, or other circulating fluids.

The present invention is described as a LNG vaporizer which inherently is meant to include the heating and vaporization of liquid and the heating of vapor. The vaporizer can be used to heat and vaporize other fluids in addition to LNG. Other fluids can be heated in the vaporizer or are cooled in the vaporizer or are condensed in the vaporizer.

The LNG vaporizer design for a specific application includes an analysis of vaporizer performance. The analysis includes heat transfer, velocity, pressure drop, fluid and material properties and icing considerations. The vaporizer can be designed to meet the application requirements. Examples of the vaporizer inherent design flexibility include the spiral tube gap spacing and arrangement, the tube size, the length of each circuit, the number of heating medium passes, the support, baffle and plenum arrangement, the containment vessel arrangement, and inlet, interstage and outlet arrangements. The vaporizer has installation flexibility. It can be installed below grade, above grade or partly below grade.

Many LNG vaporizers are required to operate at high pressures and have high design pressures. These vaporizers can have design pressures exceeding 1000 psig. The LNG manifold and heat transfer circuit arrangement of the present invention is appropriate for high pressure designs.

The long heat transfer circuits of the present invention contribute to balanced flow distribution and stable flows during design and normal turndown conditions. The vaporizer has high heat capacitance and the long spiral tube circuits reduce the potential for liquid carryover.

The LNG inlet manifold arrangement and size limit the accumulation of high molecular weight hydrocarbon liquids. The outlet gas composition of the present invention during operation is essentially the same as the inlet liquid composition.

The present invention discloses a LNG vaporizer with operational advantages. The spiral tube circuit design provides flexibility to accommodate tube movement during temperature changes. Individual circuits can cool down or warm up at different rates without high thermal stresses. The spiral heat transfer circuit is less susceptible to thermal stress resulting from exchanger surface area temperature differences that can be created by surface area fouling. The vaporizer can be quickly cooled down. The vaporizer configuration and flexibility permits start up to proceed from cool down to operational status quickly. The vaporizer shutdown can be rapid. The vaporizer provides reliable continued operation with stable flow and a stable LNG composition.

The present invention can be utilized at LNG import terminals, LNG peak shaving and satellite facilities, LPG facilities, ethane facilities, carbon dioxide facilities, liquid nitrogen facilities, propane facilities, ammonia facilities, and other heating or vaporization applications. The compact and rugged apparatus could be used on a LNG ship or an offshore LNG terminal to vaporize the LNG. The vaporized LNG would flow directly to gas mains on shore.

The present invention can be used to provide cooling duty. It could be used at LNG fueled gas turbine installations. The refrigeration available in the LNG could be used to pre-cool the gas turbine inlet combustion air or provide cooling for other applications or for inlet air cooling and for other cooling duties. The heat removed in providing the cooling duty provides the heat for vaporizing the LNG.

### FEATURES

Several features of this invention follow:
The invention provides an effective heat transfer arrangement to reliably vaporize LNG.
The flexible spiral tube circuit can accommodate differential thermal movement.
The device provides very high capacity LNG vaporization means.
The invention can be designed with a unique heating medium arrangement to help keep particles in suspension.
The cross flow heating medium flow passage provides heat transfer at high rates.
There are no heating medium flow dead spots as a result of shell baffles.
The device can directly vaporize LNG with energy efficient heat sources such as sea water, river water, waste heat or cooling tower water and other heat sources such as water from a submerged combustion water heater, or heat from a gas turbine installation.
The invention can be adapted to directly vaporize LNG with heat sources containing particulate matter.
The vaporizer has features which accommodate quick and easy start-up and shut-down operations.
The LNG manifold arrangement is ideal for high operating and high send-out pressures.
The vaporizer provides stable flow and vapor outlet composition at the full range of design flow rates. The vaporizer has high heat capacitance with less potential for liquid carry over.
The spacing of tubes can be configured to accommodate tube icing and heating medium flow.
Individual heat transfer tubes and circuits can cool down or warm up at different rates without high thermal stresses.
The device can be tailored to use various heating mediums. Many vaporizer variables can be configured in the design phase to accommodate the application requirements.
The device can be part of a LNG vaporizer package which includes a submerged combustion heat source.
The device can heat and vaporize many fluids in addition to LNG.
The vaporizer provides a rugged and compact means for vaporizing LNG
The products of combustion from a submerged combustion heat source do not impinge or contact the LNG heat transfer area.
The vaporizer has installation flexibility. It can be installed below grade, above grade or partly below grade. It can be located onshore and on ship and platform locations.
The vaporizer can include a separator for removing hydrocarbon liquids from the LNG sendout stream.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. The details of the apparatus may be varied substantially without departing from the spirit of the invention, and the exclusive use of all modifications which come within the scope of the appended Claims is reserved.

1. A method of vaporizing LNG comprising the steps of:
providing at least one heating medium entrance;
providing a heating medium annular space;
providing spiral tube heat transfer circuits positioned in the annular space;
flowing LNG through the spiral tube heat transfer circuits;
flowing heating medium through at least one heating medium entrance and through the annular space; and
providing heating medium heat exchange with the spiral tube heat transfer circuits.

2. The LNG vaporizer of claim 1, further comprising one or more from the group consisting of:
(a) where a heating medium entrance is positioned generally concentric and symmetrical with the annular space;
(b) where a spiral tube heat transfer circuit and annular space is arranged to provide substantially cross flow heat transfer;
(c) where the vaporizer is provided with an interstage manifold communicating with the spiral tube circuits;
(d) where the interstage manifold provides means for liquid separation;
(e) where the heating medium flows in two passes through the annular space;
(f) where a spiral tube heat transfer circuit is generally supported on support rods, tubes or bars;
(g) where various fluids including LNG are heated and vaporized or vaporized or heated or cooled or condensed;
(h) where the heating medium provides the heating duty;
(i) where several heat sources provide the heating duty or where the heating medium contains particulate matter;
(j) where other types of heat transfer circuits are included;
(k) where rows of spiral tube heat transfer circuits are generally supported on support rods and the support rods for a row are positioned to provide vertical clearance between a row of spiral tube heat transfer circuits and the support rods supporting the row of spiral tube heat transfer circuits located above and allowing independent movement of each row of spiral tube heat transfer circuits;
(l) where the fabrication sequence includes placing a spiral tube heat transfer circuit generally within the annular space followed by placement of a successive spiral tube heat transfer circuit row;
(m) where the tube pitch of selected tubes within a spiral tube heat transfer circuit is adjusted to accommodate tube icing or adjusted to accommodate heating medium flow or both.

3. A LNG vaporizer comprising:
rows of spiral tube heat transfer circuits for containing and vaporizing LNG;
at least one inlet manifold and at least one outlet manifold; wherein spiral tube heat transfer circuits communicate with at least one inlet manifold;
at least two annular space shell plates disposed to form a heating medium annular space; wherein rows of spiral tube heat transfer circuits being positioned generally within the annular space;
a heating medium inlet plenum communicating with the annular space; and
a heating medium outlet plenum communicating with the annular space.

4. The LNG vaporizer of claim 3, further comprising one or more from the group consisting of:
(a) where the heating medium inlet plenum is positioned generally concentric and symmetrical to the annular space;
(b) where at least one heating medium entrance communicates with a heating medium inlet plenum;
(c) where a heating medium entrance is positioned generally concentric and symmetrical with the annular space;
(d) where the heating medium inlet plenum, annular space, and heating medium outlet plenum are arranged to provide heating medium flow turbulence;
(e) where a spiral tube heat transfer circuit and annular space is arranged to provide substantially cross flow heat transfer;
(f) where the vaporizer is provided with an interstage manifold communicating with the spiral tube circuits;
(g) where the interstage manifold provides means for liquid separation;
(h) where the heating medium flows in two passes through the annular space;
(i) where a spiral tube heat transfer circuit is generally supported on support rods, tubes or bars;
(j) where various fluids including LNG are heated and vaporized or vaporized or heated or cooled or condensed;
(k) where the heating medium provides the heating duty;
(l) where several heat sources provide the heating duty or where the heating medium contains particulate matter;
(m) where the heating medium is in heat exchange contact with heat transfer circuits;
(n) where shell gap baffle bars communicate with annular space shell plates;
(o) where other types of heat transfer circuits are included;
(p) where rows of spiral tube heat transfer circuits are generally supported on support rods and the support rods for a row are positioned to provide vertical clearance between a row of spiral tube heat transfer circuits and the support rods supporting the row of spiral tube heat transfer circuits located above and allowing independent movement of each row of spiral tube heat transfer circuits;
(q) where the fabrication sequence includes placing a spiral tube heat transfer circuit generally within the annular space followed by placement of a successive spiral tube heat transfer circuit row;
(r) where the tube pitch of selected tubes within a spiral tube heat transfer circuit is adjusted to accommodate tube icing or adjusted to accommodate heating medium flow or both.

5. A LNG vaporizer comprising:
rows of spiral tube heat transfer circuits for containing LNG;
at least two annular space shell plates disposed to form a heating medium annular space; wherein the rows of spiral tube heat transfer circuits being positioned generally within the annular space;
a vaporizer heating medium inlet plenum communicating with the annular space;
a vaporizer heating medium outlet plenum communicating with the annular space;
a submerged combustion heat source with a submerged combustion heat source inlet plenum and a submerged combustion heat source outlet plenum; wherein the vaporizer heating medium outlet plenum communicates with the submerged combustion heat source inlet plenum and the vaporizer heating medium inlet plenum communicates with the submerged combustion heat source outlet plenum; and
at least one pump circulating heating medium from the vaporizer heating medium outlet plenum, through the submerged combustion heat source and through the annular space for heat exchange with the spiral tube heat transfer circuits.

6. The LNG vaporizer of claim 5, further comprising one or more from the group consisting of:
(a) where a spiral tube heat transfer circuit and annular space is arranged to provide substantially cross flow heat transfer;
(b) where the vaporizer is provided with an interstage manifold communicating with the spiral tube circuits;
(c) where the interstage manifold provides means for liquid separation;
(d) where the heating medium flows in two passes through the annular space;
(e) where a spiral tube heat transfer circuit is generally supported on support rods, tubes or bars;
(f) where various fluids including LNG are heated and vaporized or vaporized or heated;
(g) where the heating medium provides the heating duty;
(h) where several heat sources provide the heating duty or where the heating medium contains particulate matter;
(i) where shell gap baffle bars communicate with annular space shell plates;
(j) where other types of heat transfer circuits are included;
(k) where rows of spiral tube heat transfer circuits are generally supported on support rods and the support rods for a row are positioned to provide vertical clearance between a row of spiral tube heat transfer circuits and the support rods supporting the row of spiral tube heat transfer circuits located above and allowing independent movement of each row of spiral tube heat transfer circuits;
(l) where the fabrication sequence includes placing a spiral tube heat transfer circuit generally within the annular space followed by placement of a successive spiral tube heat transfer circuit row;
(m) where the tube pitch of selected tubes within a spiral tube heat transfer circuit is adjusted to accommodate tube icing or adjusted to accommodate heating medium flow or both.
